(19) United States
(12) Patent Application Publication
(10) Pub. No.: US 2008/0034330 A1
(43) Pub. Date: Feb. 7, 2008

(54) INFORMATION PROCESSING APPARATUS

(75) Inventor: Yukihiro Kurita, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/777,182

(22) Filed: Jul. 12, 2007

(30) Foreign Application Priority Data
Aug. 7, 2006 (JP) 2006-214818

(51) Int. Cl. G06F 3/048

(52) U.S. Cl. 715/856

(57) ABSTRACT

According to one embodiment, an information processing apparatus displaying a cursor movable based on an operation signal from an operation unit includes a display unit which displays on the display screen a first cursor controlled by an operating system and a second cursor controlled by a content playback software, and a display control unit configured to determine and display a display location of the second cursor within a window based on the location from which the first cursor to be entered the window area, in the case where an operation to move the first cursor into the window area from outside the window area has occurred when the content playback software is windowed on part of the display screen.

### CROSS-REFERENCE TO RELATED APPLICATIONS

This application is based upon and claims the benefit of priority from Japanese Patent Application No. 2006-214818, filed Aug. 7, 2006, the entire contents of which are incorporated herein by reference.

### BACKGROUND

1. Field

One embodiment of the invention relates to a cursor-control technique suitable for application in an information processing apparatus, such as a personal computer having a function to playback an HD DVD (High Definition Digital Versatile Disc).

2. Description of the Related Art

In recent years, along with the progress of digital encoding techniques of moving images, a player capable of handling HD (High Definition) standard high-resolution images is growing popular. Recently, software development is underway to handle this HD standard high-resolution image on personal computers.

Since a cursor is defined in an HD DVD Video standard, a player must be provided with a function to control the display of this cursor. Accordingly, for instance, when this player function is realized as the software to be operated on a personal computer, an independent cursor for the said software to control display within the window allocated thereto will exist in addition to a standard cursor possessed by an operating system. Therefore, the two cursors will coexist on the personal computer in which the said software is operating.

Under a so-called multiwindow environment, various proposals have been made so far regarding control means to allow a user to simply select and operate a desired cursor from among a plurality of cursors displayed on the same screen (for example, refer to Jpn. Pat. Appln. KOKAI Publication No. 5-289843).

Meanwhile, in the HD DVD Video standard, there is no regulation set down on the behavior of the cursor in the case where a player function is realized as a software operating under an operating system possessing a cursor. In other words, the cursor defined in the HD DVD Video standard is not considered in conjunction with the standard cursor possessed by the operating system.

However, in consideration of user usability, it is preferred that a mutually engaged control, such as carrying out handover by a series of pointing device operation, is carried out between the standard cursor possessed by the operating system and the independent cursor of which the software realizing the player function controls display within the window allocated thereto.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective diagram illustrating an overview of a computer concerned in an embodiment of the present invention.

FIG. 2 illustrates an exemplary system configuration of the computer of the embodiment.

FIG. 3 is an exemplary conceptual diagram for explaining an AV content image configuration of an HD DVD Video standard.

FIG. 4 illustrates an exemplary functional block concerned in the image processing of an HD DVD player application program which operates on the computer of the embodiment.

FIG. 5 exemplifies a display screen when the HD DVD player application program of the computer of the embodiment is in operation.

FIG. 6 is an exemplary first diagram for explaining a cursor control realized in the HD DVD player application program of the computer of the embodiment.

FIG. 7 is an exemplary second diagram for explaining the cursor control realized in the HD DVD player application program of the computer of the embodiment.

FIG. 8 is an exemplary third diagram for explaining the cursor control realized in the HD DVD player application program of the computer of the embodiment.

FIG. 9 is an exemplary fourth diagram for explaining the cursor control realized in the HD DVD player application program of the computer of the embodiment.

FIG. 10 is an exemplary fifth diagram for explaining the cursor control realized in the HD DVD player application program of the computer of the embodiment.

FIG. 11 is an exemplary sixth diagram for explaining the cursor control realized in the HD DVD player application program of the computer of the embodiment.

FIG. 12 is an exemplary seventh diagram for explaining the cursor control realized in the HD DVD player application program of the computer of the embodiment.

FIG. 13 is an exemplary eighth diagram for explaining the cursor control realized in the HD DVD player application program of the computer of the embodiment.

### DETAILED DESCRIPTION

Various embodiments according to the invention will be described hereinafter with reference to the accompanying drawings. In general, according to one embodiment of the invention, an information processing apparatus displaying a cursor movable based on an operation signal from an operation unit includes a display unit which displays on the display screen a first cursor controlled by an operating system and a second cursor controlled by a content playback software, and a display control unit configured to determine and display a display location of the second cursor within a window based on the location from which the first cursor to be entered the window area, in the case where an operation to move the first cursor into the window area from outside the window area has occurred when the content playback software is windowed on part of the display screen.

Firstly, the configuration of an information processing apparatus concerned in an embodiment of the present invention will be explained. For example, this information processing apparatus can be realized as a notebook type personal computer 10.

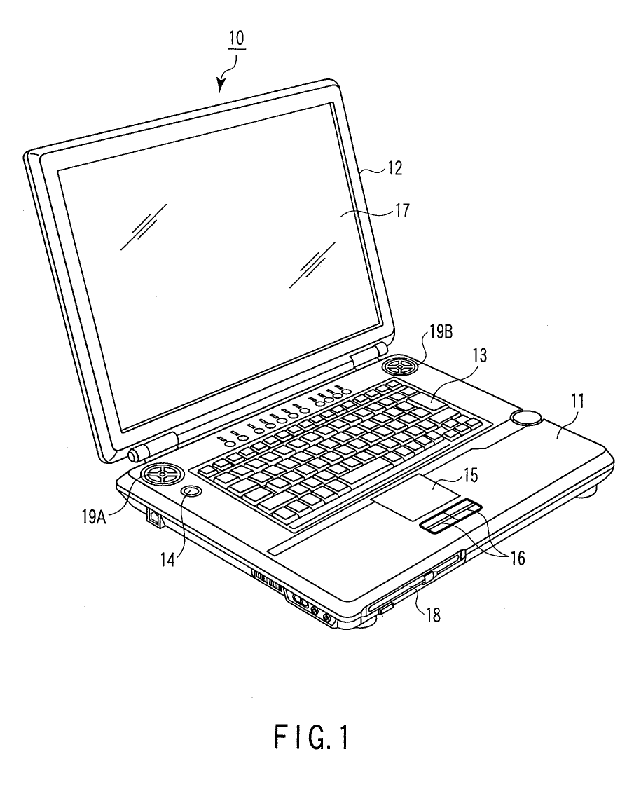

FIG. 1 is an exemplary perspective diagram of the notebook type personal computer 10 in a state where its display unit is opened. The present computer 10 comprises a computer body 11 and a display unit 12. The display unit 12 is configured with a display device comprising a TFT-LCD (Thin Film Transistor Liquid Crystal Display) 17. The display screen of the TFT-LCD 17 is positioned approximately in the center of the display unit 12.

The display unit 12 is attached to the computer body 11 so that it can be adjusted freely between the opened/closed position with respect to the computer body 11. For instance, the computer body 11 is a thin box chassis, and a keyboard 13, a power button 14 to switch the power of the computer 10 on/off, a touch pad 15, a click button 16 and speakers 19A and 19B are arranged on its upper surface.

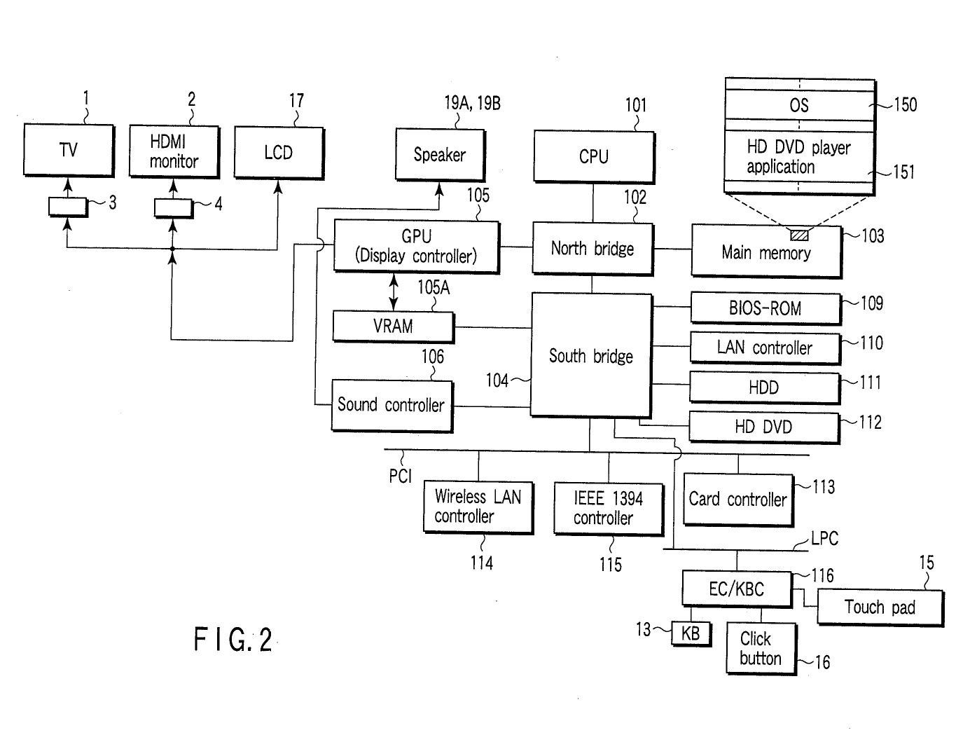

Further, the present computer 10 is able to playback (HD DVD Video standard) audio video (AV) content stored on an HD DVD standard DVD media. On the front side of the computer body 11 is a slot 18 to insert and eject the DVD media. The system configuration of the present computer 10 will be explained with reference to FIG. 2.

As shown in FIG. 2, the present computer 10 comprises, for example, a CPU 101, a northbridge 102, a main memory 103, a southbridge 104, a graphics processing unit (GPU) 105, a video memory (VRAM) 105A, a sound controller 106, a BIOS-ROM 109, a LAN controller 110, a hard disk drive (HDD) 111, an HD DVD drive 112, a card controller 113, a wireless LAN controller 114, an IEEE 1394 controller 115 and an embedded controller/keyboard controller (EC/KBC) 116.

The CPU 101 is a processor to control the operation of the present computer 10 and executes various programs loaded from the HDD 111 to the main memory 103. Among the various programs executed by this CPU 101 are an operating system 150 and an HD DVD player application program 151 which reproduces the HD DVD Video standard AV content. Further, the CPU 101 executes the BIOS (Basic Input Output System) stored in the BIOS-ROM 109. The BIOS is a program to control the hardware.

The northbridge 102 is a bridge device which connects the local bus of the CPU 101 and the southbridge 104. The northbridge 102 also incorporates a memory controller to control access of the main memory 103. The northbridge 102 also has a function to execute communications with the GPU 105 via, for example, a PCI EXPRESS standard serial bus.

The GPU 105 is a display controller to control the LCD 17 which is used as a display monitor of the present computer 10. The GPU 105 has an image processing function, such as blending process, scaling processing and luma-key processing. The display signal generated by this GPU 105 is transmitted to the LCD 17. Further, the display signal can be sent to an external TV 1 and external HDMI monitor 2 via an interface 3 and an interface 4 respectively. The interfaces 3 and 4 are provided in the computer body 11.

The southbridge 104 controls each device on a PCI (Peripheral Component Interconnect) bus and each device on a LPC (Low Pin Count) bus. Further, the southbridge 104 incorporates an IDE (Integrated Drive Electronics) controller to control the HDD 111. It also has a function to execute communications with the sound controller 106.

The sound controller 106 is a sound source device which outputs an audio data for playback to the speakers 19A and 19B.

The card controller 113 controls cards, such as a PC card and an SD (Secure Digital) card. The wireless LAN controller 114 is a wireless communication device to execute, for example, an IEEE 802.11 standard wireless communication. The IEEE 1394 controller 115 executes communication with external devices via an IEEE 1394 standard serial bus.

The EC/KBC 116 is a 1-chip microcomputer integrating an embedded controller for power management and a keyboard controller for controlling the keyboard (KB) 13, the touch pad 15 and the click button 16. By operating the touch pad 15, an operation signal is generated, and the cursor displayed on the display screen of the LCD 17 moves based on this operation signal. Further, this EC/KBC 116 has a function to turn the power of the present computer 10 on/off in accordance with the power button 14 operated by a user.

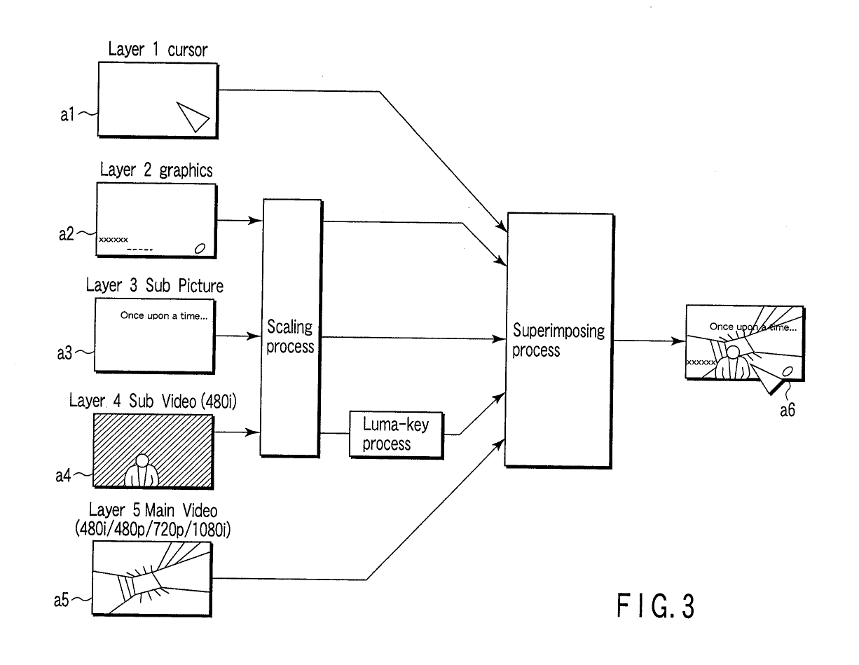

The image configuration of the HD DVD Video standard AV content will be explained with reference to FIG. 3.

In the HD DVD Video standard, five layers of layer 1 to layer 5 are defined. Each layer is allocated a cursor, graphics, sub picture, sub video and main video, respectively. Therefore, the HD DVD Video standard AV content stored on the DVD media includes a main video data, sub video data, sub picture data, graphics data and navigation data (and additionally includes a main audio data and sub-audio data as an audio data).

The navigation data further includes a script (XML). This script is a data for controlling the display of graphics data and cursor in accordance with, for example, the pointing device (the touch pad 15 and the click button 16) operated by the user. The script can give a description of, for instance, the shape of the cursor and the area in which the cursor can be arranged.

First of all, among the five images a1 to a2 of the layers 1 to 5, the scaling process is applied on the images a2 to a4 of the layers 2 to 4. The luma-key process is further applied on the image a4 of the layer 4. After completing these scaling process and luma-key process, a desired image a6 is produced by superimposing the five images 1a to 5a of the layers 1 to 5 (blending process).

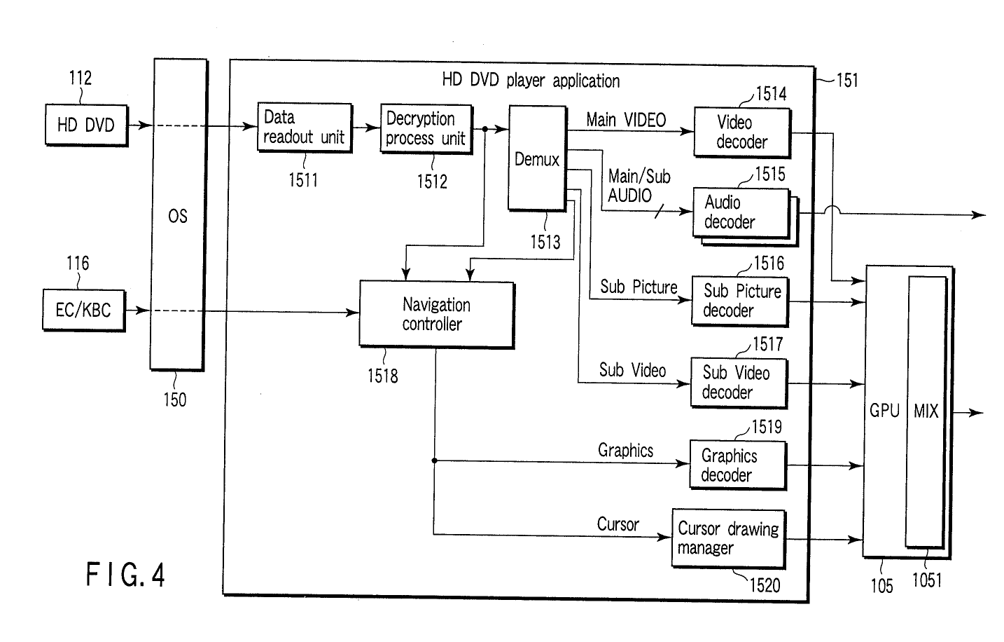

FIG. 4 shows an exemplary functional block concerned in the image processing of the HD DVD player application program 151 which reproduces the HD DVD Video standard AV content having such image configuration.

The HD DVD player application program 151 is a so-called application program operating under control of the operating system 150. As shown in FIG. 4, the HD DVD player application program 151 comprises, for instance, a data readout unit 1511, a decryption process unit 1512, a demultiplexer (Demux) 1513, a video decoder 1514, an audio decoder 1515, a sub picture decoder 1516, a sub video decoder 1517, a navigation controller 1518, a graphics decoder 1519 and a cursor drawing manager 1520.

The data readout unit 1511 retrieves the HD DVD Video standard AV content (main video data, sub video data, sub picture data, main audio data, sub-audio data, graphics data and navigation data) stored on the DVD media, by the HD DVD drive 112. The main video data, sub video data, sub picture data, main audio data, sub-audio data, graphics data and navigation data are encrypted respectively, and the main video data, sub video data, sub picture data, main audio data, sub-audio data and graphics data are multiplexed as an HD DVD stream.

The main video data, sub video data, sub picture data, main audio data, sub audio data, graphics data and navigation data retrieved by this data readout unit 1511 are input respectively to the decryption process unit 1512. The decryption process unit 1512 executes a process to decrypt each data. The decrypted navigation data and the HD DVD stream are transmitted respectively to the navigation controller 1518 and the Demux 1513.

The Demux 1513 separates the main video data, main audio data, sub audio data, sub picture data, sub video data and graphics data from the HD DVD stream. The separated main video data is transmitted to the video decoder 1514, the separated main audio data and sub audio data are transmitted to the audio decoder 1515, the separated sub picture data is transmitted to the sub picture decoder 1516 and the separated sub video data is transmitted to the sub video decoder 1517, and are decoded. Further, the graphics data is handed over to the navigation controller 1518.

Meanwhile, the navigation controller 1518 analyzes the script (XML) included in the navigation data and controls the display of the graphics data handed over from the Demux 1513. The graphics data is transmitted from the navigation controller 1518 to the graphics decoder 1519 and decoded. Based on this script, the navigation controller 1518 establishes a cursor area in which the cursor is movable, and, within this cursor area, controls the display of the cursor by moving the cursor in accordance with the pointing device operated by the user, which is sensed by the EC/KBC 116.

The cursor is drawn by the cursor drawing manager 1520 under the instructions of the navigation controller 1518. In consideration with the user's convenience, the present computer 10 controls the cursor defined as layer 1 in the HD DVD Video standard in conjunction with the standard cursor possessed by the operating system 150. The following describes the above points in detail.

The main video data decoded by the video decoder 1514, the sub picture data decoded by the sub picture decoder 1516, the sub video data decoded by the sub video decoder 1517, the graphics data decoded by the graphics decoder 1519, and the cursor plotted by the cursor drawing manager 1520 are subject to the blending process, which is accompanies the scaling process and the luma-key process by the GPU 105. The GPU 105 has a mixer (MIX) 1051 to carry out this blending process.

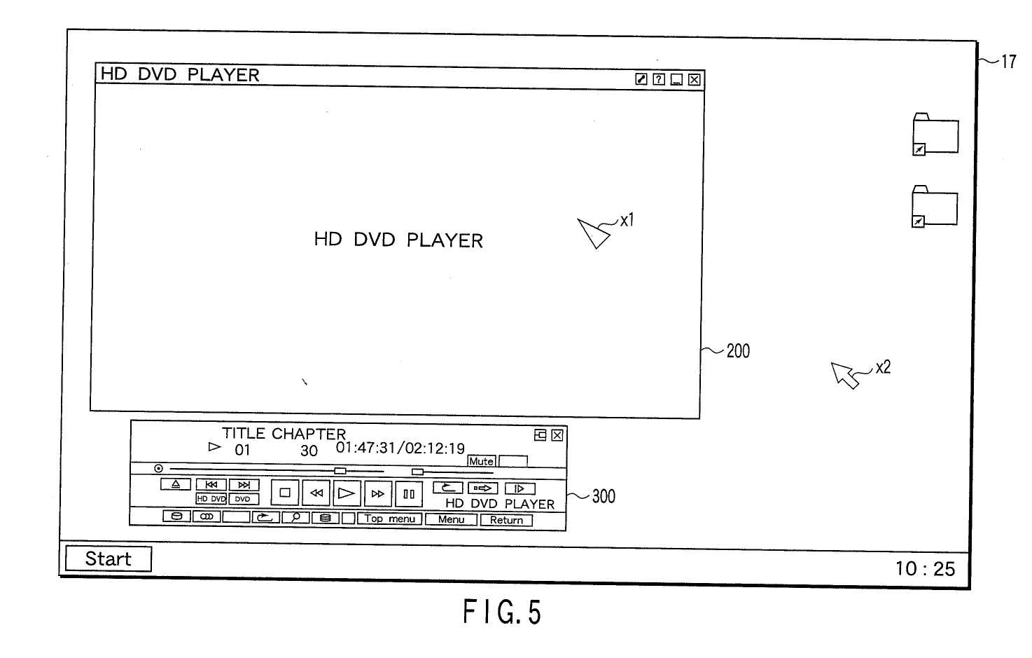

FIG. 5 exemplifies the display screen of the LCD 17 of the present computer 10 when the HD DVD player application program 151 is in operation. The HD DVD player application program 151 receives from the operating system 150 the allocation of a window 200 to display the HD DVD Video standard AV content comprising the five images of layers 1 to 5 explained in reference to FIGS. 3 and 4.

Further, the HD DVD player application program 151 receives from the operating system 150 the allocation of a window 300 to display a control panel to accept the playback operation of the AV content. The window 300 may be closed if it is considered unnecessary after, for instance, carrying out the operation to initiate the AV content playback. In the following, the window 200 may be referred to as a main window and the windows other than the window 200 (including window 300) may be referred to as sub-windows.

As shown in FIG. 5, in the case where the HD DVD player application program 151 is in operation, a cursor x1 defined as layer 1 in the HD DVD Video standard is displayed within the window 200, and a standard cursor x2 possessed by the operating system 150 is displayed outside the window 200. The basic principles for the navigation controller 1518 to carry out cursor control to move the cursor x1 in conjunction with the cursor x2 will be explained in the following.

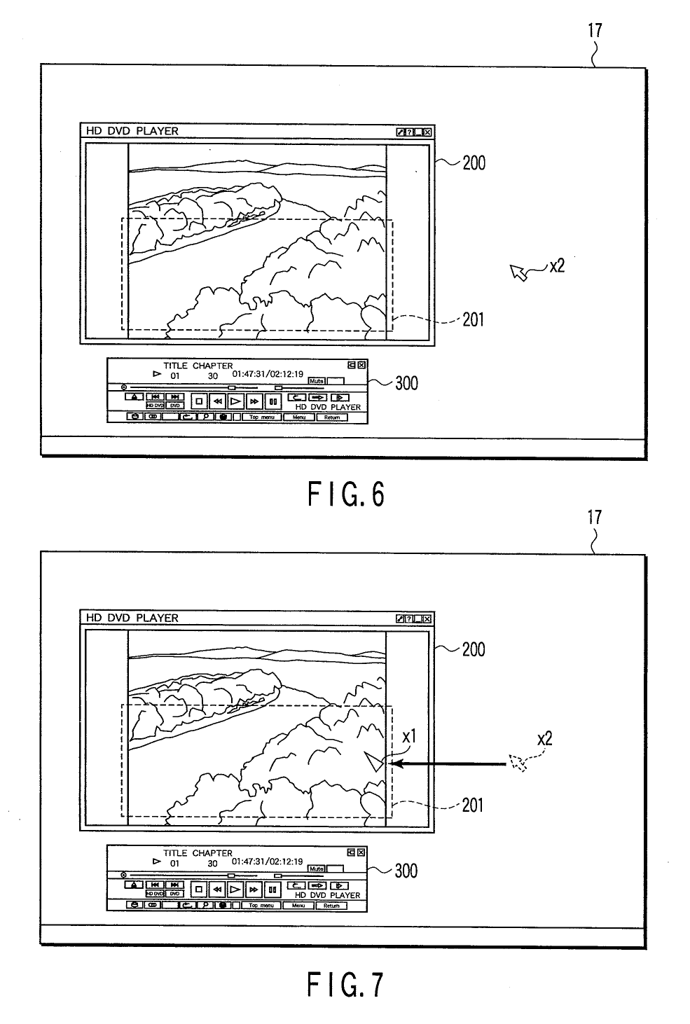

Suppose the main window 200 and the sub-window 300 are currently allocated on the display screen of the LCD 17 as shown in FIG. 6. The area (201) boxed in dotted line within the main window 200 is a cursor area defined by the script included in the navigation data. In the main window 200, it is possible to move the cursor only in the cursor area 201.

The user operates the touch pad 15 to designate any location on the display screen on the LCD 17. In the case where the designated location enters the display area of the main window 200, the operating system 150 notifies the offset value within the said main window 200 to the navigation controller 1518 of the HD DVD player application program 151. Subsequently, each time the touch pad 15 is operated, the operating system 150 notifies the navigation controller 1518 of the moved distance from the previously designated location.

Having received this notice for the first time after the cursor area 201 is established, the navigation controller 1518 initiates displaying the cursor x1 which is unique to the AV content wherein the shape etc. is defined by the script included in the navigation data. Accordingly, only the standard cursor x2 of the operating system 150 is displayed until the navigation controller 1518 receives this notice. Such state is illustrated in FIG. 6.

Further, in the case where the script also defines the initial display location of the cursor x1, the navigation controller 1518 immediately displays the cursor x1 on the defined location without waiting for this notice. In the case where the script does not define the shape of the cursor x1, the navigation controller 1518 displays the cursor x1 in a shape predesignated in the case where the shape is undefined, which is different from the standard cursor x2 of the operating system 150.

In this state, the cursor x2 moves when the touch pad 15 is operated (pointing device operation). As shown in FIG. 7, now the case in which this cursor x2 enters into the main window 200 is considered. When the location designated by the pointing device operation is within the main window 200, the operating system 150 notifies the navigation controller 1518 of the location as mentioned above.

When moving the cursor x2 as shown in FIG. 7, its entrance location (right end of the main window 200) will be outside the cursor area 201. In such case, the navigation controller 1518 displays the cursor x1 in a location nearest to this entrance location within the cursor area 201. Since the cursor x1 is displayed in a shape defined by the script included in the navigation data, from the user, it is viewed as if the cursor x2 changes to the cursor x1 and jumps into the cursor area 201 just as the cursor x2 moves into the main window 200.

Subsequently, the cursor x1 starts moving when the pointing device is operated. FIG. 7 shows that the cursor x1 is displayed in a different shape from cursor x2. However, in the case where the script defines the shape to be the same as the cursor x2, both the cursors x1 and x2 will be displayed in the same shape.

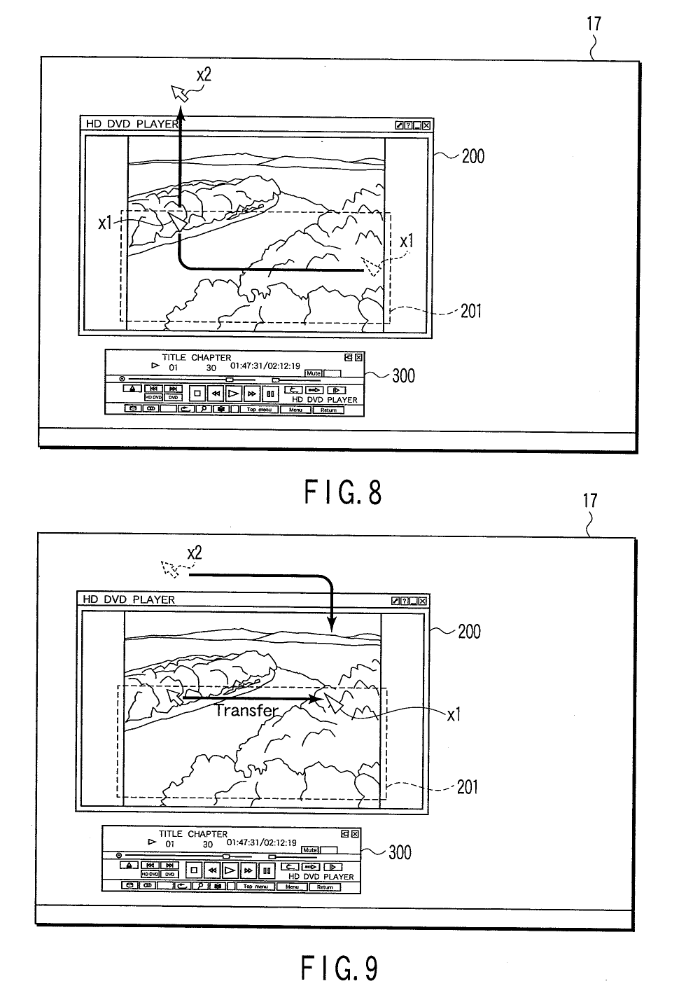

As shown in FIG. 8, now the case in which this cursor x1 is moved to the left side within the main window 200 and all the way up and out of the cursor area 201 is considered. When the cursor x1 is moved in such manner, a location will be designated within the main window 200, but outside the cursor area 201. In such case, firstly, the navigation controller 1518 gives instructions to the operating system 150 to move the target location of the pointing device operation to the nearest location outside the main window 200, off the cursor area 201. Thus, the cursor x2 will be displayed in the said location outside the main window 200.

Secondly, the navigation controller 1518 continuously displays the cursor x1 so as to leave the latest cursor x1 in the cursor area 201 of the main window 200 displayed. As a result, as shown in FIG. 8, there will be two cursors x1 and x2 displayed simultaneously on the display screen of the LCD 17. Accordingly, to the user, the moment the cursor x1 moves outside the cursor area 201 of the main window 200, it looks as though the cursor x1 changes to the cursor x2 and jumps outside the main window 200 while remaining inside the cursor area 201. Subsequently, the cursor x2 will now move when the pointing device is operated.

Further, as shown in FIG. 9, the case in which this cursor x2 is moved to the right, outside the main window 200, and down into the main window 200 is considered. When the cursor x2 is moved in such manner, the navigation controller 1518 displays the cursor x1 in a location nearest to the entrance location within the cursor area 201 as explained in reference to FIG. 7. However, in this case, the cursor x1 from the time of leaving the cursor area 201 earlier remains displayed within the cursor area 201. Therefore, the navigation controller 1518 controls the display so that the remaining cursor x1 is seen as if it is transferred to the location where it should be displayed in accordance with the current pointing device operation.

In this manner, to the user, the moment the cursor x2 is moved into the main window 200, it looks as though the cursor x1 within the cursor area 201 responds to the cursor x2 and replaces it. Subsequently, when the pointing device is operated, the cursor x1 now moves.

In such manner, the navigation controller 1518 controls the display of the cursor x1 within the cursor area 201 of the main window 200 so that it moves in conjunction with the movement of the cursor x2 outside the main window 200. Therefore, the usability for users can be improved, for instance, by handing over the movements of the cursor between the cursors in a series of pointing device operations.

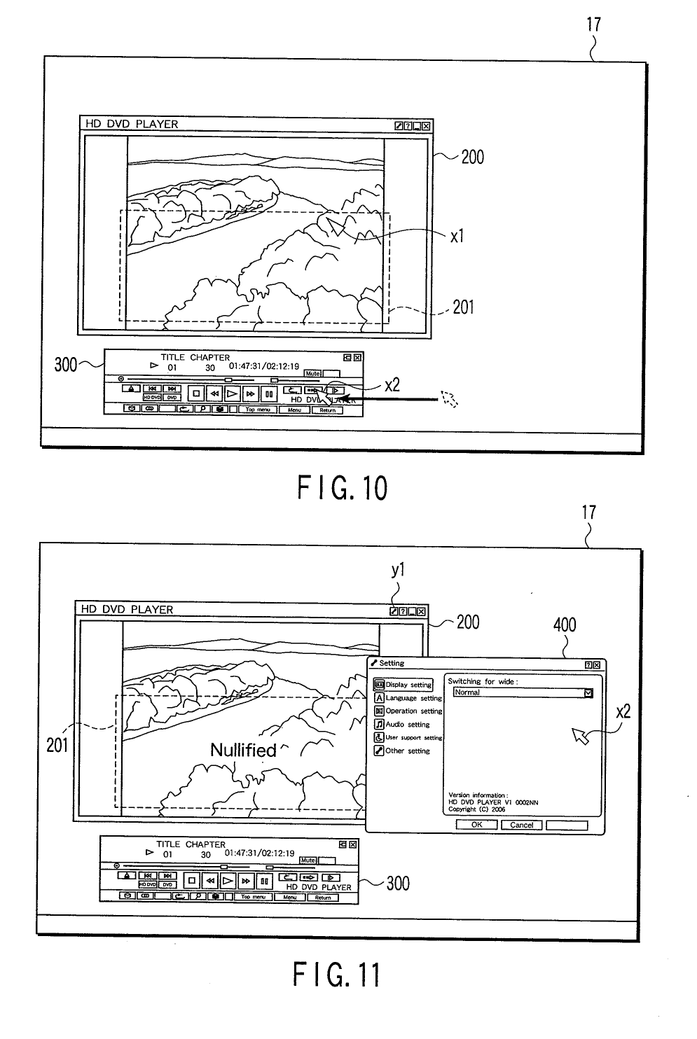

Meanwhile, the sub-window 300 to display a control panel is also a window allocated to the HD DVD player application program 151. In the present HD DVD player application program 151, the navigation controller 1518 does not carry out display control as mentioned above even when the cursor x2 enters this display area. Accordingly, as shown in FIG. 10, the cursor x2 will simply be displayed on the said sub-window 300.

Further, the HD DVD player application program 151 has a function to display a setup screen for the user to arbitrarily setup a playback environment for the AV content. As shown in FIG. 11, this setup screen is displayed by receiving the allocation of a sub-window 400 from the operating system 150 anew when the menu yl displayed on the menu bar of the main window 200 is operated. The navigation controller 1518 nullifies the cursor area 201 established within the main window 200 during the period of displaying this setup screen. This prevents the main window from any unintentional input by the user during the display period of the setup screen.

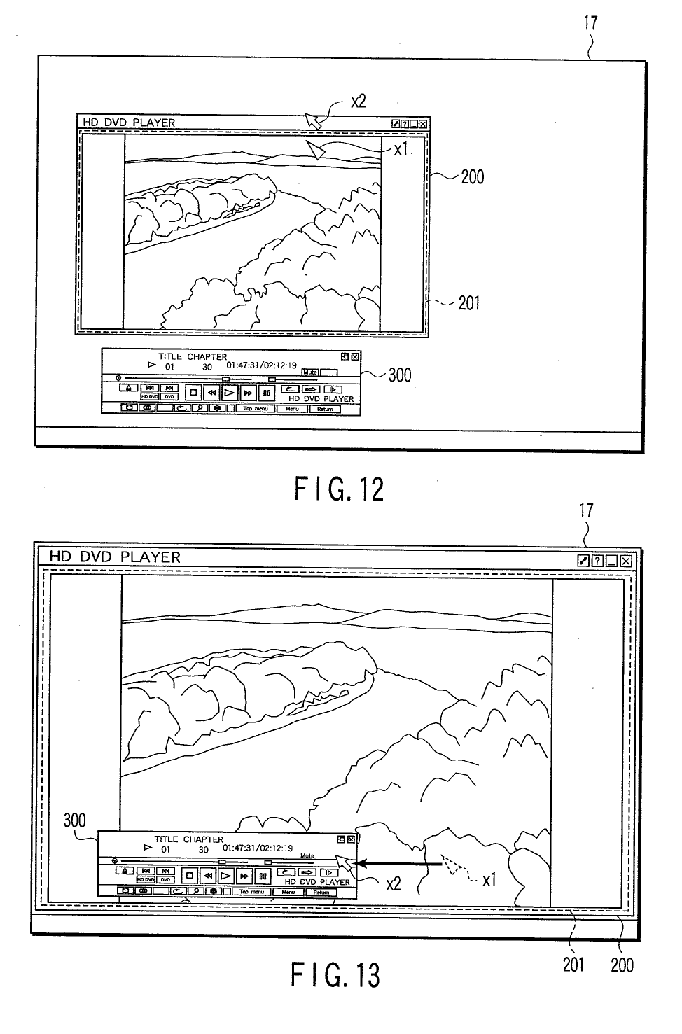

Further, the extent in which the location information based on the pointing device operation within the main window 200 is notified from the operation system 150 to the HD DVD player application program 151 excludes the portion of the menu bar. Accordingly, if the script defines the entire area of the screen to be the cursor area 201, the cursor area 201 is to be established in an entire area excluding the menu bar within the main window 200 as shown in FIG. 12. Therefore, when the cursor x1 of the cursor area 201 is moved to the menu bar, the cursors x1 and x2 are displayed side by side. The cursor x2 is used for menu operations, such as, to display the setup screen illustrated in, for instance, FIG. 11.

Further, a case is considered in which the main window 200 displaying AV content with a script defining the entire area of the screen as a cursor area 201 is displayed full-screen on the LCD 17's display screen as shown in FIG. 13, and the control panel sub-window 300 is displayed overlapping this main window 200. This means that the control panel sub-window 300 overlaps the cursor area 201 of the main window 200. In this case, the navigation controller 1518 reestablishes the cursor area in order to exclude this overlapping portion from the cursor area 201. As a result, the pointing device operation which is essentially for the cursor x1 to move within the cursor area 201 can be converted to move out of the cursor region 201. This enables the user to operate the control panel by the cursor x2 as shown in FIG. 13. The same control is performed in the case where windows of other application programs overlap and are displayed on the main window 200.

As explained above, the present computer 10 enables the two coexisting cursors to be controlled appropriately in accordance with the pointing device operation, when the content defining the cursor is reproduced under a multiwindow environment.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus configured to display a cursor movable based on an operation signal from an operation unit, comprising:
a display unit configured to display on the display screen a first cursor controlled by an operating system and a second cursor controlled by a content playback software; and
a display control unit configured to determine and display a display location of the second cursor within a window area based on the location from which the first cursor can enter the window area from outside the window area.

2. The information processing apparatus according to claim 1, wherein;
the content playback software comprises a program to playback an HD DVD (High Definition Digital Versatile Disc) Video standard content; and
the display control unit display is configured to display a cursor defined as layer 1 in the HD DVD Video standard as the second cursor.

3. The information processing apparatus according to claim 1, wherein the display control unit is configured to determine the display location of the second cursor to a location nearest to the location from which the first cursor enters the window area, the display location of the second cursor being included within a cursor area which is established within the window and where the second cursor is allocatable.

4. The information processing apparatus according to claim 1, wherein the display control unit is configured to display the first cursor and the second cursor in different shapes.

5. The information processing apparatus according to claim 3, wherein the display control unit is configured to display the first cursor to a nearest location out of the cursor area outside the window area, in the case where an operation to move the second cursor out of the cursor area from the cursor area is carried out.

6. The information processing apparatus according to claim 5, wherein the display control unit is configured to leave the latest second cursor displayed within the cursor area, in the case of displaying the first cursor outside the window area by carrying out the operation to move the second cursor out of the cursor area from the cursor area.

7. The information processing apparatus according to claim 6, wherein the cursor control unit is configured to move the remaining second cursor in compliance with the operation of the operation unit, in the case where the second cursor remains within the cursor area when carrying out the operation to move the first cursor into the window area from outside the said window area.

8. The information processing apparatus according to claim 1, wherein the display control unit is configured to display the first cursor on a location from which the second cursor enters the operation panel area, in the case where an operation is carried out to move the second cursor from outside the operation panel area into the operation panel area when the content playback software is windowed full-screen on the display screen and an operation panel to carry out operation related to content playback is displayed overlapping the window.

9. The information processing apparatus according to claim 1, wherein the display control unit is configured to handle an area other than a menu bar displaying a list of menu entry within the window as the window area.

10. The information processing apparatus according to claim 3, wherein the display control unit is configured to excludes the segment overlapped by the operation panel within the cursor area from the cursor area, in the case where an operation panel to carry out operation related to a content playback is displayed overlapping the cursor area.

11. The information processing apparatus according to claim 3, wherein the display control unit is configured to nullify the cursor area while a setup screen to carry out various setups related to a content playback is being displayed.

12. The information processing apparatus according to claim 3, wherein the display control unit is configured to nullify the cursor area while other windows are displayed and are in active states.
